(19) United States
(12) Patent Application Publication
(10) Pub. No.: US 2004/0159603 A1
(43) Pub. Date: Aug. 19, 2004

(54) Rotary-disc device dynamic filtering

(76) Inventors: Pascal Andre Charles Boulnois, Dreslincourt (FR); Roger Bouzerar, Abbeville (FR); Michel Yves Jaffrin, Compiegne (FR); Patrick Roger Daniel Paullier, Thourotte (FR)

Correspondence Address: YOUNG & THOMPSON, 745 SOUTH 23RD STREET 2ND FLOOR, ARLINGTON, VA, 22202

(21) Appl. No.: 10/483,715

(22) PCT Filed: Jul. 16, 2002
(86) PCT No.: PCT/FR02/02535

(30) Foreign Application Priority Data
Jul. 16, 2001 (FR) 0109487

(51) Int. Cl. B01D 35/12

(52) U.S. Cl. 210/331; 210/346; 210/321.87; 210/486

(57) ABSTRACT

The invention concerns a modular dynamic filtering device with rotary discs comprising membranes (41, 42, 51, 52) arranged on either side of fixed support plates (4, 5). The modular construction enables the filtering device to be universal and adaptable by the user to be used for different types of filtration from microfiltration to nanofiltration, and even reverse osmosis.

This invention relates to a modular dynamic filtration device with rotary disk(s) comprising diaphragms arranged on either side of fixed supporting plates. Modularity enables the polyvalence of the filtration device according to the invention, which may be adapted by the user to applications ranging from low pressures to high pressures, above 20 bars, i.e. from microfiltration to nanofiltration, even reverse osmosis.

Dynamic filtration devices with rotary disks are known for their capacity to provide high fluxes of permeate and notably greater than those obtained with conventional tangential filtration systems, notably in the case of loaded and pointing fluids. Such modules also enable to work at low pressures through diaphragms in microfiltration, which is interesting for extracting macromolecules from fermentation worts or milk worts, whereas the absence or the reduction of deposit facilitates transmission by the diaphragm.

Such modules exhibit however the shortcoming of being complex (mobile parts, tightness problems), which translates by cost of manufacture vastly higher than conventional systems.

Moreover, such systems can only be used in a given filtration field, for a range of set pressures, generally small.

Thus, the dynamic separation system DMF marketed by the PALL Company, comprising filtering stators fitted with diaphragm, separate by rotary disks (or rotors), may only be used at pressures lower than or equal to 3 bars, and not beyond, i.e. solely in microfiltration. The diaphragms are already assembled on the stators and their assembly and disassembly is difficult.

This invention therefore relates to a modular dynamic filtration device with rotary disks, which remedies the shortcomings of the previous art.

This invention therefore relates to a modular dynamic filtration device with rotary disk comprising:

a cylindrical enclosure (E) including:

a base, a crown and a lid, said lid comprising an upper face and a side wall which may be imbedded in said crown,

at least two filters F₁ and F₂ dividing the enclosure into at least three compartments, each of said filters comprising a supporting plate stationary fixed to the enclosure, and two diaphragms arranged on either side of said supporting plate,

at least one rotary disk, arranged between two consecutive filters,

at least one common device for injecting of a liquid to be filtered, said injection device running through the base of the enclosure, or the upper lid,

at least one common device for discharging the residue obtained from the liquid to be filtered, said residue discharging device running through an upper face of the lid of the enclosure,

at least two devices for discharging the filtrate obtained from the liquid to be filtered, said devices for discharging the filtrate running through the crown of the enclosure, and

a shaft forming the axis of said enclosure carrying the disk(s) and liable to be driven into rotation which drives into rotation the rotary disk(s).

According to the invention, the filtration device is modular, and two consecutive supporting plates are separate by a spacer for easier assembly and disassembly, changing the number of compartments, greater tightness and changing the disk-diaphragm space. Besides, the diaphragms usable according to the invention may be selected among the set of flat marketable diaphragms which can be used in the following fields: microfiltration, ultrafiltration, nanofiltration and reverse osmosis.

Advantageously, the supporting plates according to the invention are in the form of a disk with diameter d₁, and the diaphragms arranged on either side of a supporting plate according to the invention are also in the form of a disk of same diameter (diameter d₁).

Advantageously, the diameter d₁ varies from 10 to 100 cm.

Besides, the nature of the rotary disks as well as the spacing between each disk and the diaphragm closest to said disk may be adapted relative to the liquid to be filtered and its physical features.

Generally, the spacing between each disk and the diaphragm closest to said disk ranges between 2 and 20 mm.

Advantageously, the devices for discharging the filtrate are arranged in the extension of the filters F₁ and F₂ respectively.

According to a first feature of the invention, the filter is an assembly comprising a supporting plate whereof each face is fitted with a diaphragm and with a drainage layer enabling radial discharge of the filtrate towards the filtrate discharging device. The drainage layer is generally arranged between the face of the supporting plate and the diaphragm.

Advantageously, a non-woven drainage product shall be used.

When the filtration module according to the invention is used in microfiltration, the flux of permeate is relatively important, generally of the order of 2 to 10 ?/minute/m² of diaphragm. Consequently, for usage in microfiltration, the supporting plate will be advantageously fitted with radial scores for easier discharge of the filtrate.

According to another feature of the invention, the filter is a single part made of porous material, sintered or not, preferably of ceramic whereof the porosity increases towards the inside of said part, so that the diaphragms are composed of the faces of said part with lowest porosity, the supporting plate is composed of the central portion of said part with high porosity, and the drainage layers are composed of the intermediate portions with average porosity situated between the faces and the central portion of said part. The filter is preferably made of ceramic.

According still to another feature of the invention, the filter is an assembly comprising:

a supporting plate fitted with at least two ducts with diameter d₂ for lateral discharge of the permeate, and

two organic or mineral diaphragms arranged on either side of the supporting plate.

Advantageously, the ducts are radial and are connected to each face of the supporting plate by conduits with a diameter smaller than that of the ducts.

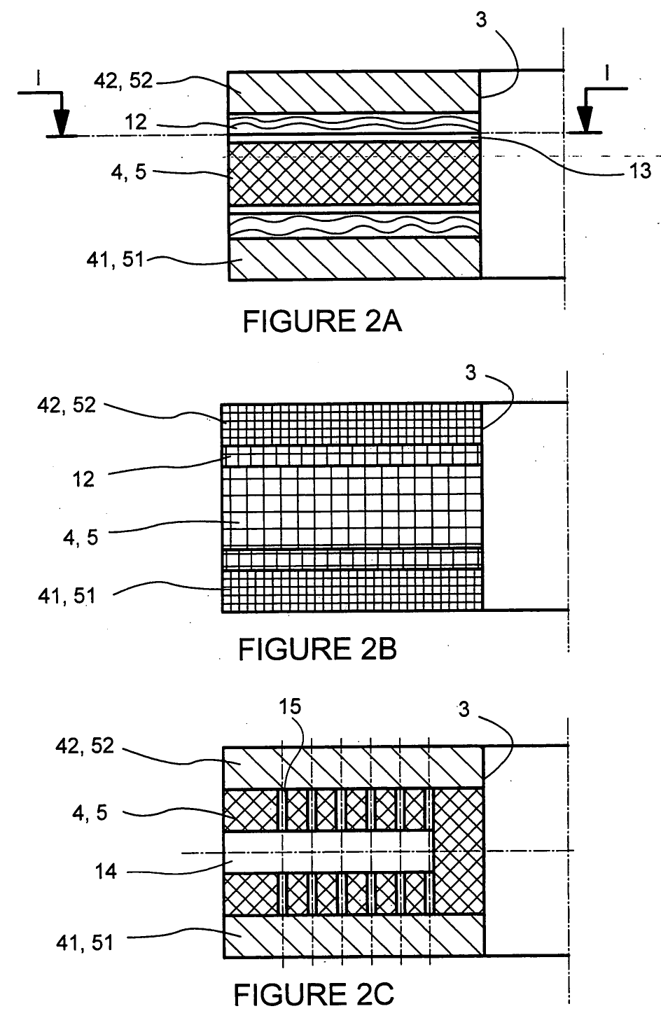

The diameter d₃ of the conduits (cf. FIG. 2) is generally smaller than the diameter d₂ of the ducts. Preferably, the diameter d₂ of the ducts is smaller than or equal to 4 mm, and preferably of 0.5 a 3 mm, and the diameter d₃ of the conduits (15) is smaller than or equal to 2 mm.

In a particular embodiment of the invention, the rotary disks are fitted with fins, preferably approximately 6 to 8 in number, and from 2 to 8 mm in height.

The presence of fins on the rotary disks enables:

for the same rotational speed, to increaser the filtration performances relative to the smooth disks thanks to better driving of the liquid to be filtered, or

for performances identical to those obtained with smooth disks, to reduce the rotational speed of the disks and therefore the energy necessary to the implementation of the filtration process.

The invention also relates to a filter composed of a single part made of porous material, sintered or not, with variable porosity, as defined according to one of the claims 11 or 12.

Finally, the invention also relates to a filter whereof the supporting plate comprises ducts and of the conduits with diameters as defined according to one of the claims 13 and 14.

The invention will be understood better and other aims, advantages and features thereof will appear more clearly when reading the following description, in conjunction with the appended drawings whereon:

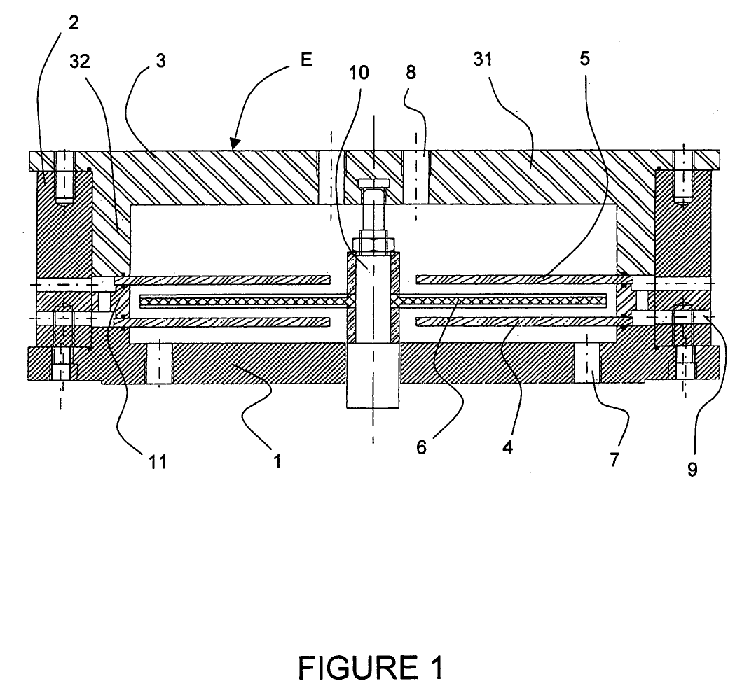

FIG. 1 shows a sectional view of an example of dynamic filtration device according to the invention comprising two filters separate by a rotary disk.

FIG. 2 represents schematically three comparative views of filters usable according to the invention, whereof the one 2A corresponds to one example of filter of the previous art and the other two 2B and 2C correspond to two examples of filters according to the invention.

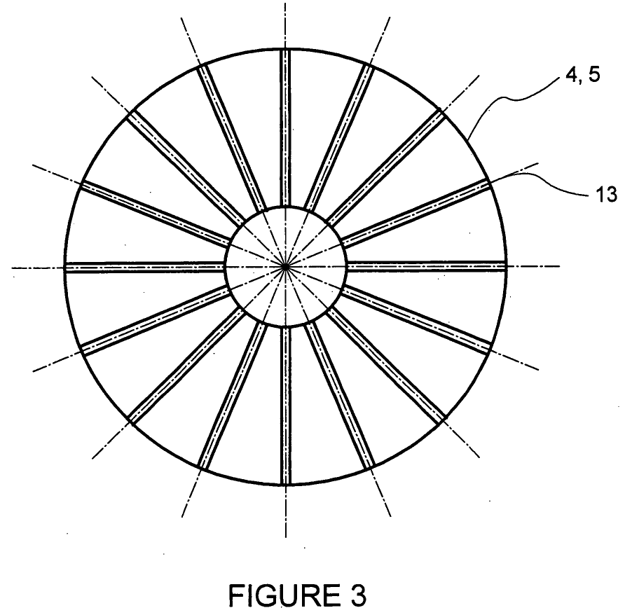

FIG. 3 represents schematically a horizontal sectional view according to the line I-I of the FIG. 1 of the supporting plate of a filter of the previous art.

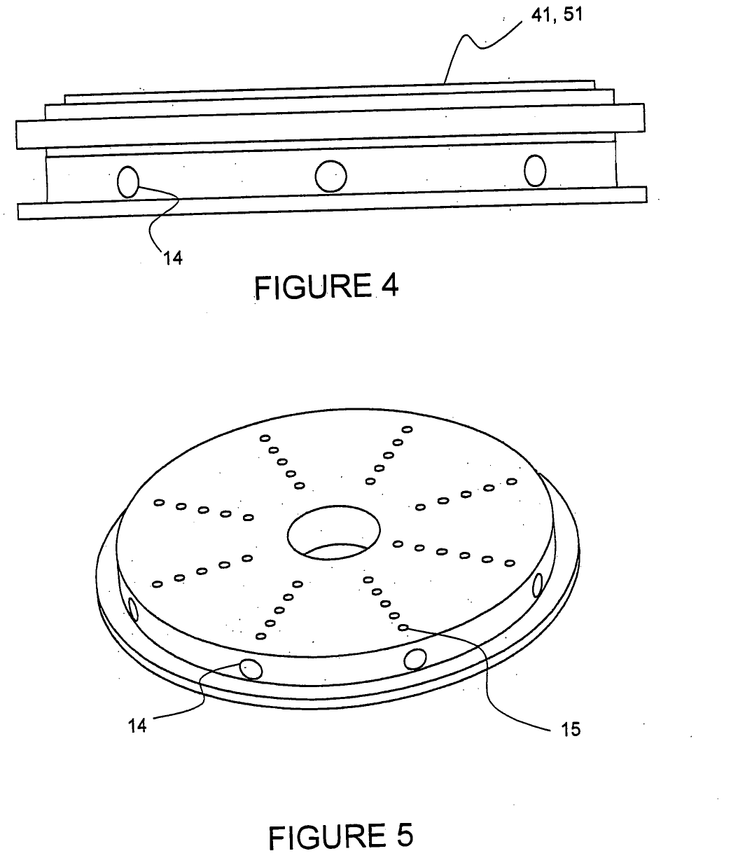

FIG. 4 represents schematically a vertical sectional view according to the line II-II of FIG. 2c of half a supporting plate of a filter according to the invention.

FIG. 5 represents schematically a lateral perspective view of half a supporting plate analogue to that represented on FIG. 4.

On FIG. 1 is represented an example of modular dynamic filtration device according to the invention including a cylindrical enclosure E comprising a circular base 1, a cylindrical crown 2 resting on the base 1 and enclosed upward by an upper face 31 of a lid 3. The side wall 32 of the lid 3 may be imbedded in the crown 2.

The inside volume of the enclosure is divided into 3 compartments (lower, intermediate and upper) by two filters in the form of stationary disks F₁, F₂, fixed at their rim outside the crown 2.

The stationary filters F₁ et F₂ are separate by a rotary disk 6 liable to rotate at high speed (4000 t/mn). This rotary disk 6 is carried by a shaft central 10 forming the axis of the enclosure E. The shaft 10 is inserted into a central hole in the filters F₁ and F₂. When the shaft 10 carrying the disk 6 is driven into rotation, it drives in turn the disk 6 into rotation.

The filters F₁ and F₂ separate by a spacer 11 placed in the side wall 32 of the lid 3 between the outer rims of the filters F₁ and F₂.

The enclosure E contains two devices for injecting a liquid to be processed running through the base 1 of the enclosure E, arranged symmetrically on either side of the central shaft 10, so that the liquid to be filtered penetrates between the crown 2, the filter F₁ and the disk through the central hole.

The portion of the liquid to be filtered running through the filter F₁ is the filtrate Fa₁.

The filtrate Fa₁ is discharged laterally from the filter F₁ to the outside of the enclosure E, through a first discharging device 91 situated in the extension of the filter F₁ and running through the crown 2 of the enclosure E.

The portion of the liquid to be filtered which has not flown through the filter F₁, and which has by-passed such filter F₁ is then collected in the intermediate compartment delineated by the filter F₂ and the disk.

The filters F₁ and F₂ are separate by the rotary disk 6. In operation, the disk 6 rotates at high speed (4000 t/mn) in order to produce high shearing effect on the diaphragms, which prevents the formation of deposits on the diaphragms, notably during the filtration of concentrated particle suspensions.

Identically to the filter F₁, the portion of the liquid to be filtered retained by the filter F₂ is the filtrate Fa₂.

The filtrate Fa₂ entering the filter F₁ is discharged laterally through a second lateral discharging device 92 situated in the extension of the filter F₂.

The portion of the liquid to be filtered which has not been filtered by both filters F₁ and F₂ form the residue.

The residue is eliminated for example through a discharging device 8, running through an upper face of the lid 3 of the enclosure E.

On FIG. 2, representing schematically 3 filters usable according to the invention, are compared the structure of a filter of the previous art (diagram A) and those of two filters according to the invention (diagrams B and C).

The diagram A of the FIG. 2 shows a filter of the previous art comprising a supporting plate 4, possibly fitted with radial scores (according to FIG. 3), on the faces thereof are arranged successively a drainage layer 12 and, a diaphragm 41, 42.

The diagram B of FIG. 2 represents schematically an example of filter according to the invention composed of a single part made of porous sintered material whereof the porosity increases towards the inside of said part. The diaphragms 41, 42 are composed of the faces of said part, since these are the portions of the part with the lowest porosity. The supporting plate (4, 5) is composed of the central portion of said part, since this portion of the part exhibits high porosity. Indeed, the drainage layers are composed of the intermediate portions with average porosity situated between the faces and the central portion of said part. The size of the pores varies from 0.1 nm to 5 μm according to whether it is reverse osmosis or microfiltration.

The diagram C of FIG. 2 as well as FIGS. 4 and 5 represent schematically another example of filter according to the invention composed of a supporting plate fitted with radial channels with diameter d₂ connected to the faces of the supporting plate by conduits with diameters d₃, smaller than d₂.

1. A rotary disk dynamic filtration device comprising:
a cylindrical enclosure (E) including:
a base (1), a crown (2) and a lid (3), said lid (3) comprising an upper face (31) and a side wall (32) may be imbedded into said crown. (2),
at least two filters F₁ and F₂ dividing the enclosure into at least three compartments, each of said filters comprising a supporting plate (4, 5) stationary fixed to the enclosure (E), and two diaphragms (41, 42, 51, 52) arranged on either side of the supporting plate (4, 5)
at least one rotary disk (6) arranged between two consecutive filters,
at least one common device for injecting (7) of a liquid to be filtered, said injection device (7) running through either the base (1) of the enclosure E, or the lid (3),
at least one common device for discharging (8) the residue obtained from the liquid to be filtered, said residue discharging device (8) running through the upper face of the lid (3) of the enclosure E or the base (1),
at least two devices for discharging (91, 92) the filtrate obtained from the liquid to be filtered, said discharging devices (9) running through the crown (2) of the enclosure (E),
a shaft (10) forming the axis of said enclosure (E) carrying the disk(s) (6) and liable to be driven into rotation,
characterised in that it is modular, and
also characterised in that:
two supporting consecutive plates (4, 5) are separate by a spacer (11) for easier assembly and disassembly, changing the number of compartments, greater tightness and changing the disk-diaphragm space,
the diaphragms are selected among microfiltration diaphragms, ultrafiltration diaphragms, nanofiltration diaphragms and reverse osmosis diaphragms.

2. A filtration device according to claim 1, characterised in that each supporting plate (4, 5) and the diaphragms (41, 42, 51, 52) arranged on either side of said supporting plate (4, 5) are in the form of a disk.

3. A filtration device according to claim 1 or 2, characterised in that the filter is an assembly comprising a supporting plate (4, 5) whereof each face is fitted with a diaphragm (41, 42, 51, 52) and a drainage layer (12) arranged between the face of the supporting plate (4, 5) and the diaphragm (41, 42, 51, 52).

4. A filtration device according to claim 3, characterised in that the drainage product (12) is non woven.

5. A filtration device according to any of the previous claims, characterised in that the supporting plate is fitted with radial scores (13) to discharge said permeate.

6. A filtration device according to claim 1 or 2, characterised in that the filter is a single part made of porous material, sintered or not, whereof the porosity increases towards the inside of said part, so that the diaphragms (41, 42, 51, 52) are composed of the faces of said part with lowest porosity, the supporting plate (4, 5) is composed of the central portion of said part with high porosity, and the drainage layers are composed of the intermediate portions with average porosity situated between the faces and the central portion of said part.

7. A filtration device according to claim 6, characterised in that the filter consists of ceramic.

8. A filtration device according to claim 1 or 2, characterised in that the filter is an assembly comprising:
a supporting plate (4, 5), fitted with at least two ducts (14) with diameter d₂ for lateral discharge of the permeate, and
two organic or mineral diaphragms (41, 42, 51, 52) arranged on either side of the supporting plate (4, 5).

9. A filtration device according to claim 8, characterised in that the ducts (14) are radial and are connected to each face of the supporting plate (4, 5) by conduits (15) with diameter d₃ smaller than the diameter d₂ of the ducts (14).

10. A filtration device according to any of the previous claims, characterised in that the disk (6) is fitted with fins (16).

11. A filter including a supporting plate (4, 5) and two diaphragms (41, 42, 51, 52) arranged on either side of said supporting plate (4, 5), characterised in that the filter is a single part made of porous material, sintered or not, whereof the porosity increases towards the inside of said part, so that the diaphragms (41, 42, 51, 52) are composed of the faces of said part with lowest porosity, the supporting plate (4, 5) is composed of the central portion of said part with high porosity, and the drainage layers are composed of the intermediate portions with average porosity situated between the faces and the central portion of said part.

12. A filter according to claim 11, characterised in that the filter consists of ceramic.

13. A filter including a supporting plate (4, 5) and two diaphragms (41, 42, 51, 52) arranged on either side of the supporting plate (4, 5), characterised in that the supporting plate (4, 5) is fitted with at least two ducts (14) for lateral discharge of the permeate.

14. A filter according to claim 13, characterised in that the ducts (14) are radial, and are connected to each face of the supporting plate (4, 5) by conduits (15).
